(19) United States
(12) Patent Application Publication
(10) Pub. No.: US 2021/0324629 A1
(43) Pub. Date: Oct. 21, 2021

(54) Unified Prefinished Panel

(71) Applicant: Elisha Halsey Brinton, Asheville, NC (US)

(72) Inventor: Elisha Halsey Brinton, Asheville, NC (US)

(21) Appl. No.: 17/065,513

(22) Filed: Oct. 7, 2020

Related U.S. Application Data
(63) Continuation of application No. 62/911,476, filed on Oct. 7, 2019.

(51) Int. Cl. E04C 3/22; E04C 2/38; E04B 1/04

(52) U.S. Cl. CPC E04C 3/22; E04B 1/04; E04C 2/382

(57) ABSTRACT

A product and a method of manufacture and assembly of a prefabricated wall panel for construction is shown and described. The present invention is directed towards minimizing the labor of multiple additive steps using many layers and materials seen in many building envelopes.

In one example, the method comprises,

A series of prefabricated residential or commercial building panels made of any of varying materials such as hemperete, fiber, cellulose, plant material, bio-aggregate, aggregate, aerated concrete, composite or inorganic materials, of substantially solid body with channel shaped elongated voids substantially located at the vertical sides as well as horizontally across their top.

Said voids in one panel are a connected channel wrapping around 3 or more sides of the panel and exposed to the exterior of said panel. Said panels are placed side by side around the perimeter of a foundation aligning the channel shaped void in one panel with the respective channel shaped void in the panel beside it creating a concrete form, or form for a load bearing material. Said panels are left in place as an integral part of the wall system. Concrete or other load bearing material is placed in said voids substantially vertically between the panels and across their tops creating an air seal and a mechanical bond between panels. The resulting concrete shape inside the wall is a post and beam structure that is substantially equidistant from the interior and exterior of the wall minimizing heat transfer through thermal bridging and minimizing weathering to the concrete. Many of the requirements of a building's wall such as the insulation, the shear strength, the rough openings for windows and doors, the interior and exterior skin, utility chases, drip edges and trim details can be met by this series of prefabricated building blocks. A method of manufacture of the building panels, the product created by that manufacture, a method of panel assembly and integration with other building components, and the finished product created by the manufacture, assembly and integration with other building components are all shown in the present disclosure.

### CROSS-REFERENCE TO RELATED APPLICATIONS

I hereby claim benefit under title 35, United States Code, Section 120 of United States patent application Ser. No. 62/911,476 (hereinafter “Prior Application”). This application is a continuation of the Prior Application. The Prior Application is currently pending. The Prior Application is hereby incorporated by reference into this application.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A SEQUENCE LISTING

Not Applicable

### STATEMENT REGARDING PRIOR DISCLOSURE

Undisclosed Publicly

### FIELD OF THE INVENTION

This invention is a method of building a wall for a structure and the way in which the wall is integrated into the foundation, upper stories, floor and roof. The invention relates to time-efficient construction methods as well as energy efficient buildings.

### DESCRIPTION OF THE RELATED ART

Any discussion of the prior art throughout the specification should in no way be considered as an admission that such prior art is widely known or forms part of common general knowledge in the field.

The art of building a structure has evolved throughout a long history of trying different materials and methods to achieve different goals. In many building styles created in the past, it was a favored method to use small components in an additive process because everything had to be carried by hand. In more recent times, heavy lifting equipment has become commonplace even on smaller job sites. A general trend towards using larger components has been shown to be time efficient. This can be seen by the use of commercial concrete tilt-up panels or prefabricated roof trusses rather than site-built rafter roof assemblies.

Standard wall building systems and super-insulated wall building systems are often complex time consuming additive processes. These building systems often use many different types of factory made materials, and they are installed in relatively small pieces by different crews. Often each material used requires different expertise and tools as seen in wood framed building with different crews of carpenters, insulators, exterior siders, sheetrockers, painters etc. Ten or more additive layers are often required to build one wood framed wall. Getting each crew scheduled is often difficult to keep a job moving without delays due to the fact that crews are often subcontractors with other projects to schedule.

When layers of standard building materials are assembled, they create an obstacle to the inevitable movement of water vapor. In many standard wall assemblies, this leads to condensation on one of the layers inside the wall or inside the building. Condensation issues can lead to mold growth and increase the chances of insect invasion. This contributes to the building's decay and leads to indoor air quality issues.

The more insulated and air sealed a building is, the more important indoor air quality becomes since the occupants will be exposed to anything that is trapped in indoor air. Therefore, it is important that water vapor passes through the walls rather than being trapped inside the wall. So one challenge for energy efficient building that is not always addressed is to keep heat in while letting vapor out.

As the specification for wall insulation value increases, often the number of layers added increases, and/or the amount of insulation, wood or foam in the wall increases. This in turn increases the related materials and labor costs. The increase in material usage also increases the building's environmental impact even as it tries to reduce that impact through energy efficiency. The cutting edge standards for energy efficiency require such a high level of insulation and air sealing that meeting these requirements through the common building technique of applying additive layers adds significant cost to the finished product.

Building energy use comprises 30-40% of global energy use; therefore, increasing building energy efficiency is of universal benefit. In a cost-driven economy, the price of highly insulated buildings needs to be equal or lower than conventional buildings in order to be adopted on a larger scale. Energy efficient buildings should be affordable for the average consumer.

One building method that works towards energy efficiency and reduction of job site waste is the use of prefabricated panels. Prefabrication of panels is known and many styles have been proposed in the prior art.

In U.S. Pat. No. 8,621,807B2, a panel is cast in forms with a layer of reinforced light hydrophobic concrete that has a void for standard concrete and one layer of concrete with vegetable fibers. This panel requires an extra step of formwork to contain the concrete post that is poured later and an extra step of creating a horizontal load bearing member. It doesn't protect the concrete from freeze-thaw or salt attack. The lightweight concrete layer is likely a water vapor barrier that would stop condensation inside the wall and against the vegetable concrete.

In U.S. Pat. No. 7,409,800 B2, a perforated adjustable width stud is interlocked with an insulated panel that houses a void that can be used for concrete. The perforated stud requires specialty equipment to manufacture. The wall requires multiple additive layers with extra steps taken to create concrete posts.

In U.S. Pat. No. 1,445,713A, Reilly establishes a masonry block with vertical channels for pouring concrete posts between two adjoining blocks. One of the embodiments says a central wall interior to said block can be precast of fiber board. The detailed description describes a cast beam element “n” that is not shown in drawings. The masonry block provides a hollow airspace in a central cavity that will likely collect condensation. The material it is made with and the shape creates a thermal bridge radiating heat through the wall at the block web and at the vertical post.

In U.S. Pat. No. 1,469,955A, Reilly further elaborates on a similar design as above and adds a dovetailed interlocking floor block. This patent also shows a block “united by connecting columns designed to support flooring slabs”

In US20050072061A1, Oscar describes a permanent form made of glass fiber reinforced concrete. The panel is prefabricated and tilted up on site. When placed side by side, the vertical sides of the panels define a three sided concrete post enclosure with the 4^{th} side being a temporary form added after rebar is placed. This system creates a structure that is almost entirely concrete which is energy intensive to produce, acts as a poor insulator and requires heavy duty lifting equipment.

In WO2006011818(A1), Harris describes a panel made of an insulating material with a tunnel through it that is completely contained within the insulating material. The tunnel is connected at it's top to a horizontal channel for a beam. The method of completely containing the concrete post inside of the insulation interior to one panel may be a missed opportunity to use the concrete to air seal between each panel and mechanically bond them together as described in the present disclosure.

In NZ 297909, a foam panel is described that has vertical and horizontal channels for concrete and tongue and groove connectors at the top and bottom edges of said panels. Multiple panels are used together to form a wall's height. This design may present difficulty in alignment and bracing of all the panels, and may cause vapor condensation issues. It requires multiple layers to be applied on panels to create a finished wall.

In FR2952660A1, Mouton discloses a prefabricated panel made in part of hemperete that allows for vertical and horizontal channels created by facing voids in like panels. Each panel is comprised of multiple additive layers of various materials which may be susceptible to condensation. Each wall height is composed of multiple blocks which may present difficulty in plumbing and bracing an entire wall. The panel construction may require specialty machinery to achieve the 3 tier interlocking system composed of different materials.

In U.S. Pat. No. 4,625,484A, Oboler describes of FIG. 12 cooperating longitudinal grooves provided in the sides of panel members. The assembly is intensive in steel and synthetic material and suggests a plastic core structure all of which have high energy use in their manufacture and otherwise high environmental impact. The panels would require specialty manufacturing equipment such as injection molding machines. The large components would require heavy duty lifting equipment, and would likely have condensation issues due to vapor impermeability.

In U.S. Pat. No. 4,343,125A Shubow, details a reinforced concrete building block module configured as a hollow rectangle with beveled corners and bevel spaces on the top, bottom and sides. Reinforcing threaded rods connect each panel and the hollow portion is to be filled with foam. This panel shows a similarity with other designs listed here in that it's exterior sides have a channel or bevel in them to receive concrete. The whole assembly would be very concrete intensive and would likely thermally bridge heat through the wall. The assembly may have condensation issues due to vapor impermeability. Custom reinforcing rods may require specialty manufacturing and may be labor intensive to install. Multiple blocks make up a floor to ceiling span which may present issues with plumbing and bracing each panel individually. A high degree of precision would be required in the tongue and groove joints between panels. Forms to manufacture a block may be relatively complex due to reinforcing bars protruding out of the finished block at different angles. Meeting code-required insulation standards may require multiple extra layers covering the blocks.

In U.S. Pat. No. 2,851,873A, Wheeler-Nicholson discribes a prefabricated building panel made of wood shreds or shavings mixed with portland cement. The panels are of full ceiling height with vertical channel and horizontal trough on the respective sides. The panels are made of cement or an insulating material sandwiched around a steel mesh that protrudes into the vertical channel. Drawings show a metal mesh inside the panel that are somehow interlocked with the mesh of the adjoining panel inside of a void. Inside the panels are hermetically sealed cavities. The patent teaches away from vapor permeability. The interior cavities and lack of vapor permeability may create condensation issues. Each panel is formed in 2 halves and before the cement is hardened, they are pressed together around the metal mesh. The manufacture of the panels may be difficult or require specialty equipment. The panel manufacture requires a buildup of multiple layers.

In U.S. Pat. No. 1,757,077A, Eiserloh describes a hollow wall tile prefabricated in large sections that in conjunction with other tiles form a vertical duct for concrete. A preformed trough is placed on top of the wall tile assembly with holes in the bottom of the trough indexing with the vertical ducts. Concrete is poured into the trough and it makes its way into the vertical ducts. This design may require specialty manufacturing equipment, may promote thermal bridging across the vertical duct and may have condensation issues due to a lack of vapor permeability. It also may require the buildup of multiple additive layers to meet code-required insulation standards.

It is known to one skilled in the art of building that if a component of a wall with the lowest thermal resistance passes horizontally through the wall or a portion of the wall, it acts as a radiator that transfers heat through the wall in a process called thermal bridging. Said component is often the load bearing member such as a stud in a stud wall. The load bearing member needs to be a denser material to hold weight, which often makes it a poorer insulator. So one of the developments of energy efficient building is to layer insulating materials around the load bearing member so it is further from the wall skin.

Many materials used in conventional construction like wood, foams, and composite or vinyl sidings have poor fire performance, and/or are susceptible to condensation, rotting, rusting and pest infiltration. Materials that are fire resistant like concrete or brick tend to require large amounts of energy in their production and/or significant labor in their installation while providing little thermal resistance. These and other issues lead to decomposition of the structure.

Though wood is considered a renewable resource, rapid deforestation practices to provide buildings for a growing population have had a negative environmental impact.

Many synthetic materials offgas volatile organic chemicals or other potentially harmful particles into interior air. If a building catches fire, these synthetics can be highly flammable and can potentially release harmful particles while burning.

Hemperete is a proven building material that has been used for centuries. Its use can provide an excellent wall system that is highly insulating, mold proof, insect proof, fire proof, is carbon negative, has no condensation point issues due to its hygroscopic nature and is stable over long time periods.

However the use of hemperete has not been adopted in mainstream building because the accepted practice of casting in situ is labor intensive.

The common method of building with hemperete is to build a stud wall, build a relatively short form on both sides of the wall, mix hemperete in a mortar mixer, carry a basket of material to the wall form and fill in by hand. Workers continue building the forms higher in steps and as the wall grows they climb a ladder with baskets to place the hemperete. It is very time consuming due to assembly and disassembly of all the forms and the relatively small volume that can be placed by a person with one trip from the mixer to the wall. Like other super-insulated wall systems, hemperete is rarely used due to higher cost compared to stud framing with plywood wall assemblies. Despite higher cost and difficulty of installation, it is still used due to the ability to achieve great insulation value and maintain vapor permeability without using synthetic materials.

When construction costs of energy efficient buildings break even with conventional building, energy efficient buildings will likely proliferate. The current disclosure addresses this long felt need by eliminating multiple labor intensive processes. The novel design of the present disclosure eliminates many additive processes seen in much of the prior art and combines them into a more time and cost efficient process. Applicant believes that improvements can be made in terms of at least one of the types of novelty methods produced and the efficiencies gained for the overall lifespan of the building.

In light of the challenges presented in the related art, clearly what is needed is a building design that simplifies the steps required to make an insulated wall that is durable, has low embodied energy, has good insulation value, minimizes thermal bridging, uses less wood, has good fire hardiness, has insect and rodent resistance and vapor permeability.

It is to these and other problems with current wall building systems that the present invention is directed.

### BRIEF SUMMARY OF THE INVENTION

In view of the foregoing disadvantages encountered in related art, the present invention discloses a new wall panel construction system, the Unified Prefinished Panel (UPP) and its manufacture and assembly in which the UPP can be used to create a building that is air sealed and energy efficient.

The prefabricated wall panel described herein has advantages of a large body of related art as well as many novel features that result in a new building system that is not anticipated, rendered obvious, suggested, or implied by any of the prior art building components or systems either alone or in any combination thereof

The present invention is directed to a method of manufacture and assembly of UPP's, and integrating that wall with the surrounding structure and utilities. A multiplicity of UPPs including different shapes to accommodate windows, doors, corners, curves, or straight wall sections are furnished and placed on a desired wall perimeter side by side with their vertical sides adjoining. Together, the panels define a void or voids that accept a load bearing material to create a post and beam load bearing structure. In this document the acronym UPP refers to the present invention and is hereinafter used interchangeably with “panel” “wall panel”, “corner panel” and “window panel”. These refer to shapes of UPP's described by their function.

A primary object of the invention is a building system that creates an air sealed and energy efficient envelope with few additive layers required for a complete wall. Another object is to prefabricate into the UPP, aesthetic or functional trim details and a finished skin on one or both sides. Another object is to simplify the building process of a structure. An additional object is an assembly that is resistant to fire, insects, rodents and mold. A further object is to provide a building envelope that is vapor permeable for regions that experience in-wall condensation issues. Another object is to provide a building system that uses materials with reduced environmental impact. An additional object is to reduce wasted raw materials in a wall assembly by reducing processes like cutting-to-size for fitment. An additional object is to provide utility chases, longitudinally open to the interior of the building that allows plumbing and electrical lines to be installed easily with substantially no drilling or cutting of UPPs. Where said chase can later be covered by baseboard or other trim. A further object is to provide a structure that may be resistant to high winds and provide an efficient means of attaching a roof securely to the walls. Another object of the invention is to achieve the aforementioned objects with a method that may be executed with commonly available equipment so that the method may be adopted or used widely without prohibitive startup costs.

These and other goals are achieved with a novel combination of filling forms of specific interior features with a flowable substrate or minimal substrates that cure into a stable, hardened state. Said substrate or substrates are selected for their unique ability to provide structural support, insulation, fire resistance, water resistance and aesthetics, yielding prefabricated UPPs whose design and assembly achieve some or all of the stated objects. Said UPPs are also a form that accommodate a load bearing material. Said load bearing material is mechanically fastened to the foundation and hurricane ties are in turn, fastened to said load bearing material.

This description is intended to summarize examples of the present disclosure. Other examples will be set forth in more detail in the figures and detailed description below. The current disclosure is also directed to methods of adaptation and use. It will be apparent that descriptions and examples are not intended to limit the present invention.

### BRIEF DESCRIPTION OF THE SEVERAL VIEWS OF THE DRAWING

These and other features, aspects, and advantages of the present invention will become better understood with regard to the following description and accompanying drawings where:

FIG. 1A illustrates an exploded plan view of prefabricated panels showing a wall panel UPP and a corner panel UPP nearby each other and ready for assembly.

FIG. 1B illustrates non exploded plan view of the wall panel UPP seen in 1A adjoining a corner panel UPP.

FIG. 1C illustrates exploded perspective view from a building interior depicting a wall UPP, a corner panel and a window panel nearby each other and ready for assembly.

FIG. 1D illustrates a perspective view of the prefabricated window panel with pre-cast trim integrated during prefabrication.

FIG. 1E illustrates a plan view of two door side panels integrated into an assembly with a wall panel UPP to the left side and a corner panel UPP to the right.

FIG. 1F Illustrates a perspective view of two door side panels and a door header panel.

FIG. 1G Illustrates a plan view of two door panels with a door buck prepared to hold the door header panel.

FIG. 1H illustrates a plan view of various UPPs shown in 1A through 1G in an assembled wall perimeter.

FIG. 1I illustrates a plan view of a 90 degree corner panel with a tapered horizontal channel void.

FIG. 2 illustrates another embodiment of a 90 degree corner panel in an “L” shape.

FIG. 3 illustrates a curved wall UPP that can join 2 other panels at a 45 degree angle.

FIG. 4A illustrates another embodiment of a 90 degree corner that is made of 2 pieces.

FIG. 4B is an exploded view of FIG. 4A.

FIG. 5 illustrates another embodiment of a 90 degree corner with decorative radii that is made of 2 pieces.

FIG. 6 illustrates a plan view of UPPs depicting an integrated corner panel that has a straight section and a 90 degree turn in one piece.

FIG. 7 illustrates an elevation section view of one embodiment with a wall UPP interfacing with a foundation and floor slab.

FIG. 8 illustrates an elevation section view of one embodiment with a wall UPP with two utility chases sitting on top of a standard cmu foundation and a concrete slab floor.

FIG. 9 illustrates an elevation section view of one embodiment with a wall UPP sitting on an insulated concrete form foundation.

FIG. 10 illustrates a perspective view of one embodiment of a reusable UPP form to create the prefabricated wall UPP first type piece.

FIG. 11 illustrates a perspective exploded view of FIG. 10, a disassembled reusable UPP form to create the prefabricated wall panel UPP first type piece.

FIG. 12 illustrates a perspective view of one embodiment of a reusable UPP form to create the prefabricated window panel UPP second type piece.

FIG. 13 illustrates a perspective exploded view of one embodiment seen in FIG. 12 of a reusable UPP form to create the prefabricated window panel second type piece.

FIG. 14 illustrates a perspective view of a window panel form with a section line.

FIG. 15 illustrates a section view of FIG. 14

FIG. 16 illustrates a mixer in position over a form to pour a substrate into the form.

### DETAILED DESCRIPTION OF THE DRAWINGS

The present disclosure describes a series of prefabricated residential or commercial building panels made of one or more of: hemperete, fiber, cellulose, plant material, bio-aggregate, aggregate, aerated concrete, composite or inorganic materials The panels are of substantially solid body with channel shaped elongated voids substantially located at the vertical sides as well as horizontally across their top or top and bottom sides. Said voids in a panel are a connected channel wrapping around three or more sides of the panel and exposed to the exterior of said panel. Said panels are placed and fastened together side by side with adhesive, spray foam or mortar around the perimeter of a foundation. Said placement aligns the channel shaped void in one panel with the respective channel shaped void in the panel beside it creating a concrete form, or form for a load bearing material. Said panels are left in place as an integral part of the wall system.

Concrete or other load bearing material is placed in said voids between the panels and across their tops creating an air seal and a mechanical bond between panels. The resulting concrete shape inside the wall is a post and beam structure that is substantially equidistant from the interior and exterior of the wall minimizing heat transfer through thermal bridging and minimizing weathering to the concrete.

UPPs are substantially rectangular prisms, but other types can be defined by curved interior and exterior faces, and still other types can be defined by the sides comprising substantially 90 degree angles or other acute or obtuse angles. It will become apparent in subsequent descriptions and claims that it is within the scope of the invention that many forms and functions can be integrally prefabricated into the UPPs by customizing the substrate used and/or the interior shape of the forms. Such details include, but are not limited to, insulating properties, shear strength, decorative features, shapes or textures, features for window placement, door placement, window flanges, drip edges, interior skin, exterior skin or trim details. It will be clear to one skilled in the art of building that any combination of UPP shapes with vertical and horizontal channel voids, with any combination of named or unnamed features, can be arranged side-by-side to create a multitude of home designs.

The present disclosure reveals a series of building panels, a method of panel assembly and integration with other building components, a method of manufacture of the building panels and the finished product created by the manufacture, assembly and integration with other building components.

In the figures attached exemplary embodiments are shown with different reference characters denoting similar elements throughout the several views.

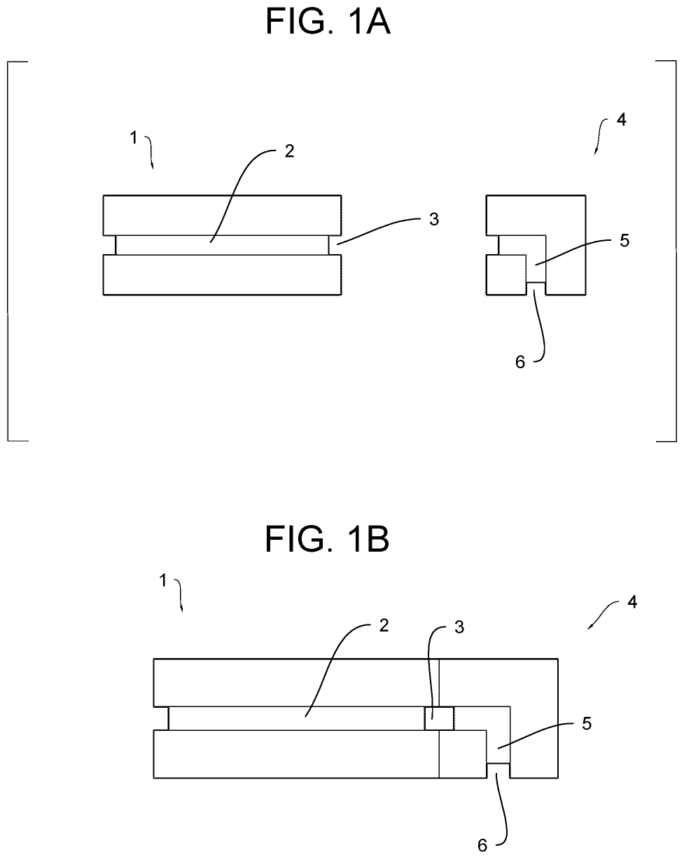

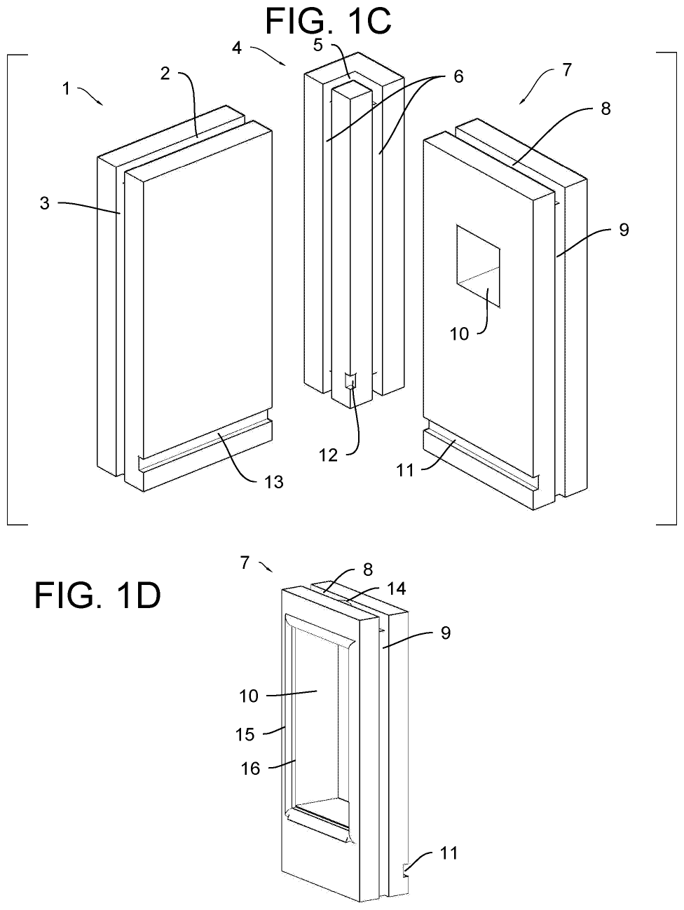

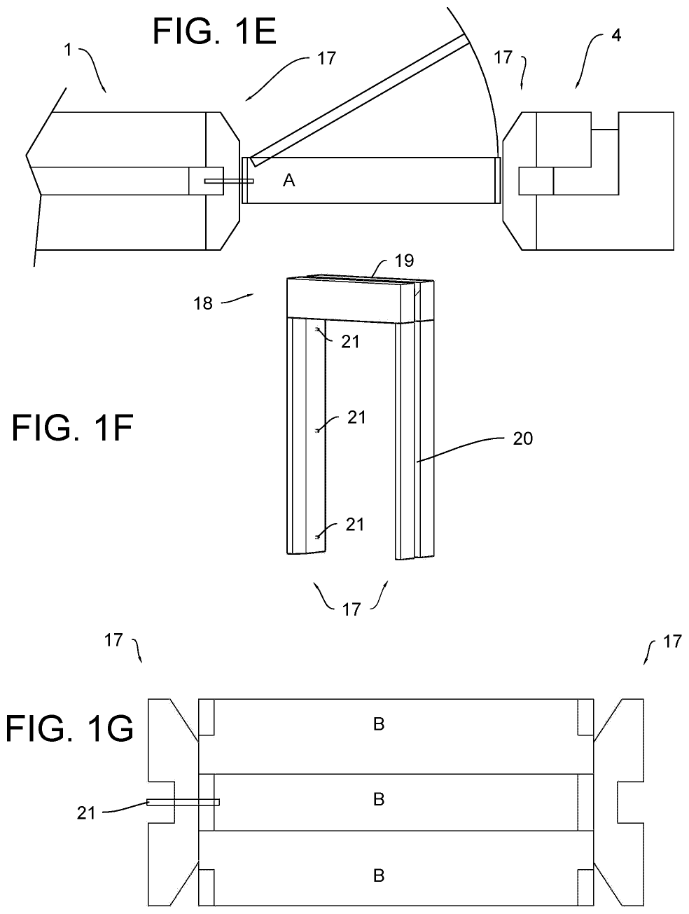

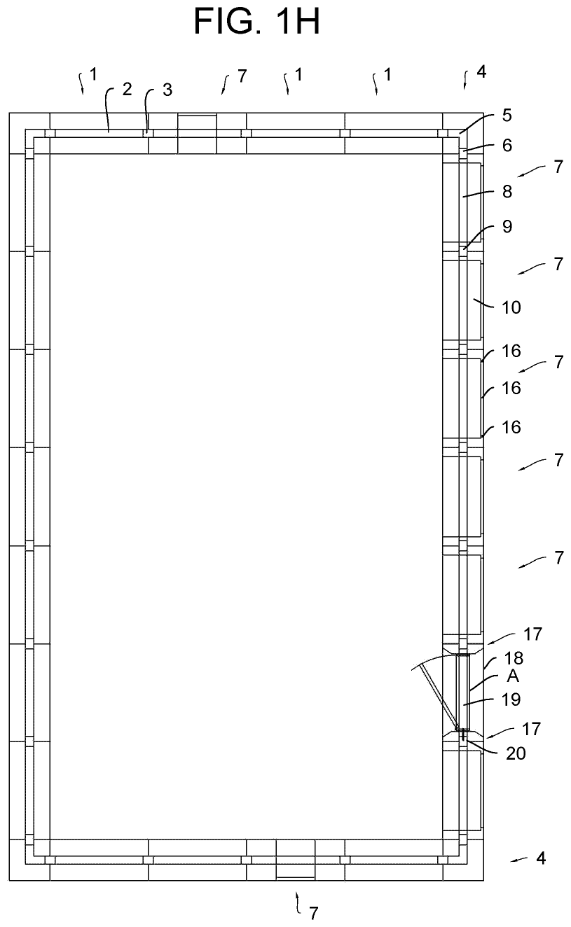

In FIG. 1A, an exploded plan view is seen of prefabricated panels showing a wall panel 1 and a corner piece 4 near each other and ready for assembly. The wall panel depicted has two vertical channel voids 3 to accommodate load bearing material to form posts as well as a horizontal channel void 2 to accommodate load bearing material to form a beam. The corner panel UPP 4 has two similar vertical channel voids 6 and a horizontal channel void 5 to accommodate load bearing materials to form posts and beam.

When two panels are assembled, an adhesive, spray foam or mortar is applied to the adjoining vertical sides before placing the panel sides together on a foundation wall.

FIG. 1B illustrates a plan view of the same parts seen in FIG. 1A with those parts assembled together. Wall panel 1 has a horizontal channel void 2 and two vertical channel voids 3. Panel 1 is seen here adjoining corner panel 4 which has corresponding horizontal channel void 5 and corresponding vertical channel voids 6. For clarity of labeling only one vertical channel void is labeled in both the wall panel UPP 1 and the corner panel UPP 4, however both 1 and 4 have two vertical channel voids visible in this view.

FIG. 1C depicts an exploded perspective view of a wall panel 1, a corner panel 4 and a window panel 7 nearby each other pre-assembly. The orientation and placement of the horizontal channel voids 2,5,8 and the vertical channel voids 3,6,9 are apparent in FIG. 1C. The window void 10 in window panel 8 is adaptable to various shape or size windows as seen in FIG. 1D. At the base of window panel 7 there is a horizontal void 11 for a utility chase. At the base of corner panel 4 there is a void 12 that cooperates with 11 after assembly as a utility chase. At the base of wall panel 1 there is a void 13 that cooperates with 12 and 11 after assembly as a utility chase. The window void 10 seen in FIG. 1D may be surrounded on the exterior by window trim 15 This window trim 15 may include integral drip edge features that urge water away from the surface of the panel. The window void may have a flange 16 intruding towards the interior of the void which serves as a surface to mount the window jamb against, removing the window from the plane of water intrusion on the exterior wall. This flange 16 also serves as a thermal break.

Note in FIG. 1D that the flange 16 does not continue across the sill. Instead the sill is sloped down to the exterior to shed water. A window header is not necessary because the UPPs are made of a substrate that is self supporting. Nevertheless, a load bearing header could be integrated into the form before the substrate is applied. Each UPP may be relatively heavy and may be lifted by equipment which can be connected to panels at hooks 14 embedded into the substrate during prefabrication. At the base of 7 the void for a utility chase in the window panel UPP 11 is visible. The vertical side of 7 has a vertical channel void 9 and a horizontal channel void 8.

An assembly for door construction is shown in FIGS. 1E-1G. FIG. 1E depicts a plan view with a cutaway of a wall panel 1 with a first door side panel 17 that is fastened or adhered to the side of said wall panel 1. Letter A depicts a standard door. On the right side of the door another door side panel 17 is seen. This is captured on it's opposite side by a corner panel 4.

In FIG. 1F a perspective view is seen with the door header panel 18 is illustrated on top of two door side panels 17. After the door assembly consisting of; two door side panels 17, door buck B seen in plan view in FIG. 1G and door header panel 18 are in place, any other UPP panel can be placed to continue a wall building sequence. The door panel assembly seen in FIG. IF has vertical channel voids 20 and horizontal channel void 19 similar to the other panels. The fastener 21 in FIG. 1F and 1G that is used to hold door buck B to side panel 17, extends into the vertical channel void 20 of its respective member allowing said anchor to fasten both into the substrate of the prefabricated panel and also the load bearing post inside of the vertical channel void. At a later stage in assembly, when door buck B is removed, fastener 21 may be left in place and used to fasten a door jamb into opening.

In FIG. 1G A plan view of a door buck B retains the space between the first door side panel 17 and the second door side panel 17.

FIG. 1H illustrates a plan view of one example of UPPs arranged into a building's wall perimeter on a foundation. In this example, the UPPs shown may be 20″ thick hemperete yielding an R-50 wall envelope with excellent thermal mass. For a given wall thickness, any corner panel shown in FIG. 1I,2,4A,5 is compatible with any: wall panel 1, window panel 7, or door side panel 17 and header 18 assembly. Underneath door header 18 there is a standard door A. It may be recognized by one skilled in the art of building that this short exemplary list of panel types could be arranged in any combination of types to create a huge variety of structure configurations and sizes. The forms for prefabrication and therefore panels can vary in size and shape yielding even more variety and design freedom than given by the examples shown. The size of the post and beam provided by the prefabrication forms are also adjustable according to requirements given by a structural engineer. For any given set of forms that create panels accommodating “x” size post and beam, a certain roof free span and number of stories is delimited. In the FIG. 1H plan view UPPs 1,4, 7,17 are depicted with their vertical sides adjoining neighboring UPPs. The placement of any sequence of UPPs aligns the complementary vertical channel voids 3,6,9,20 with the respective vertical channel void in the adjoining UPP. Further, the same said UPP placement aligns the horizontal voids 2,5,8,19 into a continuous void in the shape of a beam that substantially follows the same perimeter of the wall panels below and the foundation they are on. In one embodiment, said vertical and horizontal voids are intended to accept rebar and concrete that cures into a monolithic post and beam structure mechanically bonding each UPP to the adjoining UPPs and the foundation and further air sealing each vertical joint. FIG. 1H additionally illustrates a plan view of window panels 7 with voids 10 with a flange 16 intruding into said void for window jamb mounting.

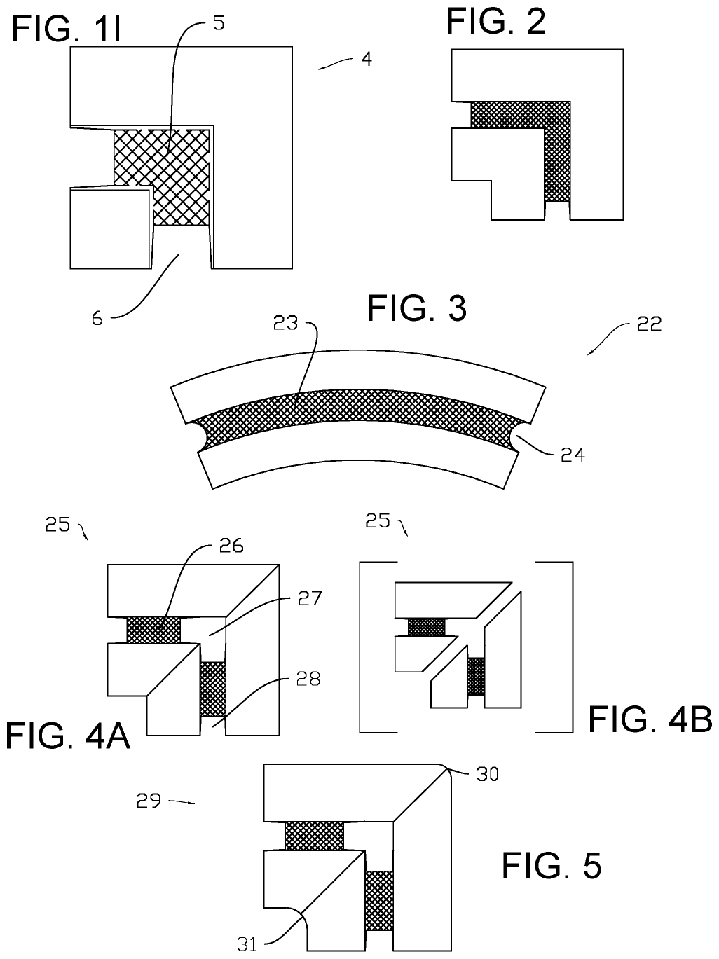

FIGS. 1I, 2,4A, 4B, 5 depict plan views of various embodiments of corner panels 1I, 2, 4A, 4B, 5 and a curved wall panel FIG. 3 that are provided for changing the direction of a wall to follow a perimeter delineated by a building plan. -FIG. 1I, has the feature of horizontal channel void 5 and vertical channel voids 6. FIG. 1I illustrates the preferred embodiment of a 90 degree corner 4 that can be joined to any wall panel 1, curved wall panel 22, window panel 7 or door panel assembly 17,18.

FIG. 2 illustrates another embodiment of a corner panel with extended flanges in plan view.

FIG. 3 depicts a curved wall panel 22 that can join two walls at a 45 degree angle. Said curved wall panel 22 shows a different embodiment of vertical channel void 24 with a half circle profile. Also pictured is a horizontal channel void 23 that follows the curved contour of the panel below it.

FIG. 4A Depicts a corner built of two separately formed pieces 25 that contains an additional central post allowance 27 that may be used where greater strength is desired or in situations where lighter or smaller panels are needed in tight spaces. As with other UPPs there are two vertical channel voids 28 and a horizontal channel void 26.

FIG. 4B is an exploded view of FIG. 4A depicting the two pieces of 25 with a space between them.

FIG. 5 illustrates a plan view of one embodiment of a corner similar in function to that of FIG. 4A but with the addition of an interior 31 and exterior 30 radius as an aesthetic feature.

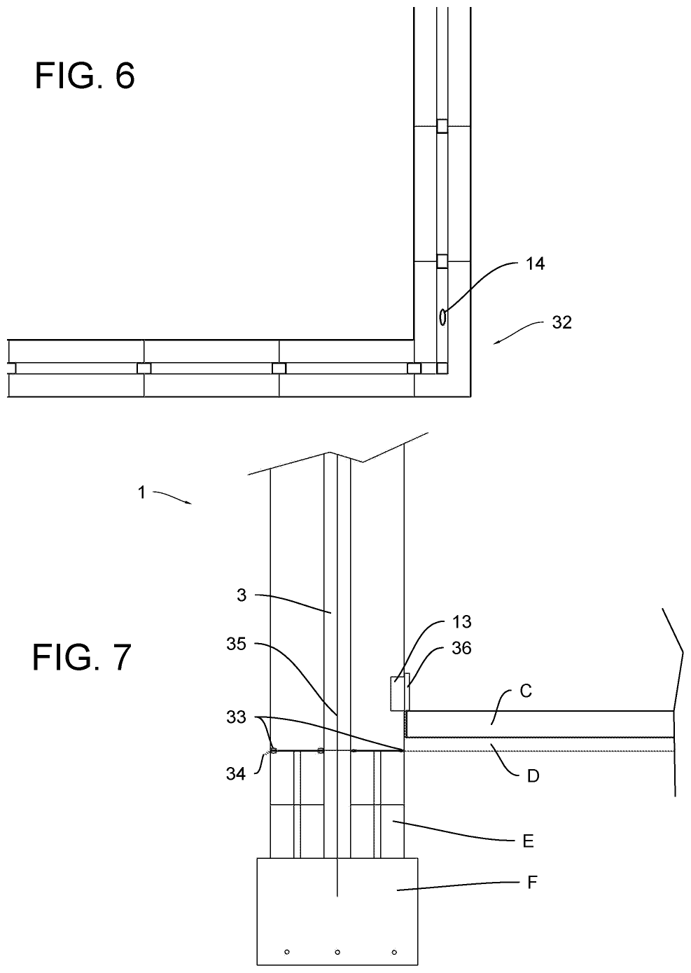

FIG. 6 is a plan view of one embodiment of UPPs in which a 90 degree corner is integrated into a wall panel 32. The integrated corner 32 shows an alternative type of void that is completely enclosed within the substrate of one panel. This type of panel would require a more complex form in order to maintain that negative space within the panel and may entail a more difficult form disassembly but the resulting panel could be a benefit for multi-story construction due to the location of the post it will house on the center of the angle. This is in contrast to the corner in FIGS. 1I, and 2 which cantilevers the compressive load slightly beyond the post. FIG. 6 further shows a lifting hook 14 which can be in any panel for ease of lifting and movement.

FIG. 7 illustrates a foundation elevation section view of one embodiment with a wall panel UPP 1 capturing the edge of a floor slab C which is on a rigid insulation D. Further, that wall panel 1 is on a foundation E, which is in turn on a footer F. The foundation and floor are not claimed in the present invention but examples of how the wall panels interface with them are given. In the present example, a portion of adhesive, spray foam or mortar 33 is placed on top of the foundation, which may provide a damp proof course, then a flashing 34 may be placed, then a panel 1 is placed and rebar 35 is placed or tied to a partial rebar protruding from the foundation and extending into vertical channel void 3. Panel 1 has a utility chase void 13 or rabbet in the surface facing into the building at the substantially lower portion of the panel and longitudinally exposed on the surface of said panel. When a multiplicity of like UPPs are placed in a perimeter creating a building's exterior walls each said utility chase void 13,11 or 12 is aligned continuously with voids in adjoining UPPs creating a ring around said perimeter. The lower surface of said ring represents the height of a concrete floor slab to be poured and said lower surface serves as a level line and screed guide for pouring, striking, troweling or floating a concrete floor C. Further, said ring also furnishes a utility chase above said floor and within the plane of the wall for efficient placement of plumbing, wiring or other utilities where said ring and utilities may be covered with a trim such as baseboard 36.

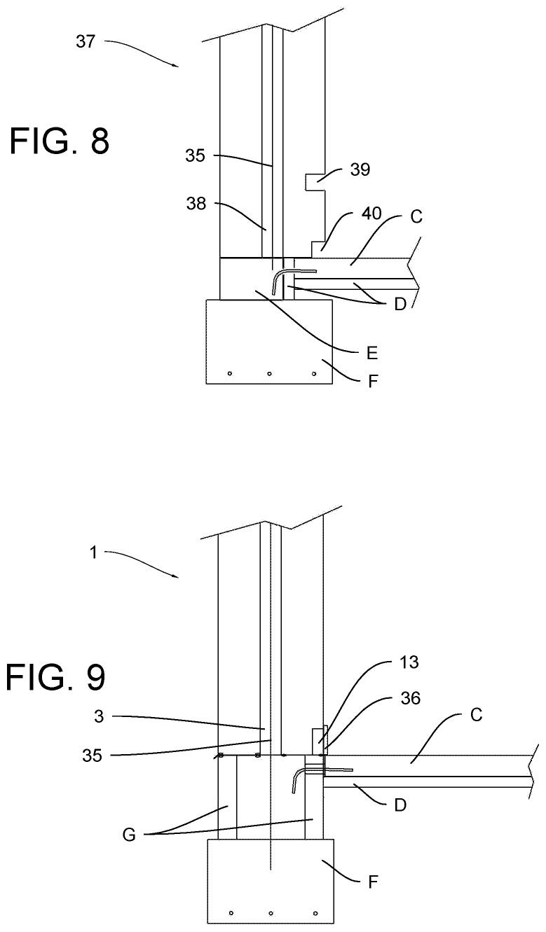

FIG. 8 illustrates a foundation elevation section view of one embodiment with a wall panel 37 with two utility chases . An upper utility chase 39 is furnished for electrical or other utilities and a lower utility chase 40 is furnished for plumbing or other utilities. Wall panel 37 is sitting on top of a standard concrete masonry unit foundation E and a concrete slab floor C. Also shown are foam insulation D and footer F. Rebar 35 spans vertically up the center of a vertical channel void 38 in this embodiment of a wall panel UPP.

In FIG. 9, a foundation elevation section view is depicted of one embodiment with a wall panel 1 sitting on an insulated concrete form foundation G. There is a vertical channel void 3 with a rebar 35 spanning vertically up the center. The UPP panel has a void for a utility chase 13 that can be covered by baseboard 36. Also shown are a concrete floor C, foam insulation D and Footer F. FIGS. 7-9 show three examples of typical foundations with the floor either under, beside, or captured by the wall. Various types of foundations, floor positions, chase positions or number of chases may be used.

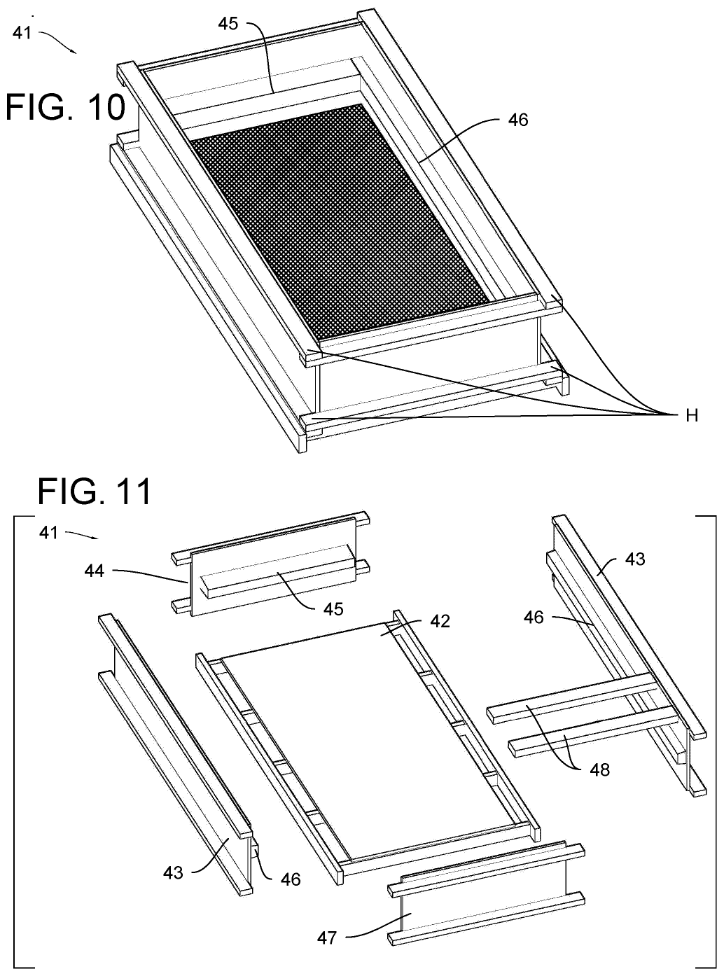

The manufacture of a UPP will be exemplified by illustration and description of a wall panel form and a window panel form and their use to create a wall panel UPP and a window panel UPP. Other types or shapes of UPPs are manufactured in very similar ways to the wall panel and window panel so they will not be described specifically. One skilled in the art of building will recognize that the method of manufacture and forming described and shown in FIGS. 10-16 can be extended, molded or adjusted to create other features that are described herein. Furthermore, additional UPP shapes or features that may be rendered obvious by the present disclosure are considered to be within the scope of this disclosure.

FIG. 10 depicts a perspective view of one embodiment of a reusable wall panel form 41 to create the wall panel 1 not shown here. In the preferred embodiment, the fabrication of a UPP is done with the forms supine so that the interior and exterior skin of the UPP is fabricated in a horizontal position. Also seen in FIG. 10 are an internal feature that creates a horizontal channel void in the UPP, an internal feature that creates a vertical channel void and a clamping or fastening location H. The example shown in FIG. 11 is an exploded perspective view of FIG. 10 with an additional feature 48 that creates utility chase void 13. The wall panel form 41 has a bottom 42, two detachable long sides 43 and a detachable short side 44 of a UPP form that creates the top of the UPP and a detachable short side 47 of a UPP form that creates the bottom of a UPP. The form has an internal feature 45 that creates a horizontal channel void, and internal features 46 that create a vertical channel void on each long side 43. Both said features 45 and 46 in this example are tapered with a three degree draft angle for ease of form release. This example is merely to show one embodiment and is not meant to limit the scope of the invention to a particular shape or draft angle. In other embodiments the profile of internal features 45 and 46 could be described by a half circle, trapezoid, octagon or other shape.

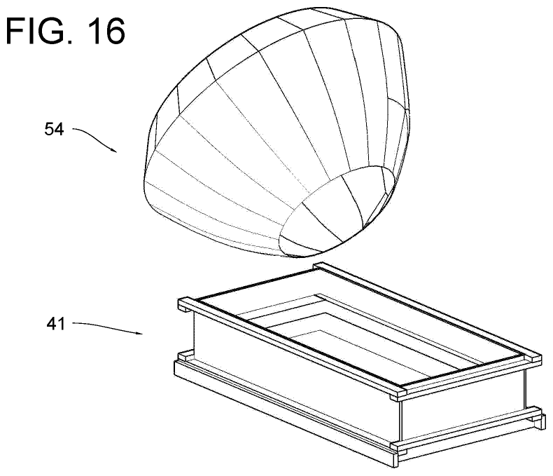

For convenience and efficiency the bottom of a UPP wall panel form 42 is placed on the floor, a mobile cart, or sawhorses and close to a substrate mixer 54 as shown in FIG. 16. A form long side 43 and a form short side 44 are put in place on 42 and fastened in at least one of location H. In the preferred embodiment the fastener is a quick release clamp. The other form long side 43 and form short side 47 are put into their positions and clamped at H. lifting hook 10 (not shown) is suspended inside the form with one portion of it penetrating through (not shown) the internal feature 45 that creates horizontal channel void. An internal feature 48 that creates utility chase void 13 is fastened to form long sides 43 or placed in notches (not shown) in form long sides 43. A substrate is mixed and poured or placed into the form. After a time period for curing, the clamps or fasteners can be removed from H, and the sides 43,44,47 can be removed from the cast panel. The panel can undergo further curing at this stage or be transported to storage or a job site for assembly. Substrate material in all embodiments is initially a flowable liquid or a semi-solid or any state of matter between liquid and semi-solid that can take the shape of the interior of said reusable form and retain said shape. Said material shall for the purposes of this document be referred to as the substrate.

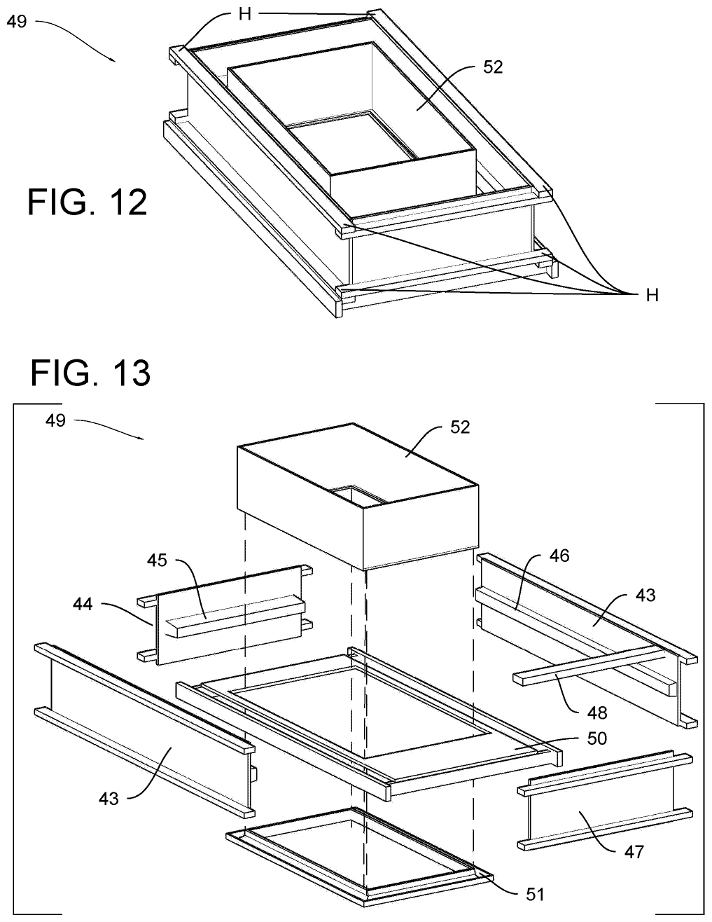

FIG. 12 depicts a perspective view of one embodiment of a reusable window panel form 49 to create the window panel 7. The example shown in FIG. 13 is an exploded perspective view of FIG. 12 with an additional feature 48 that creates utility chase void 11. The window panel form 49 is a eight piece form that uses many parts in common with the wall panel form 41. It has a bottom, 50 two detachable long sides 43, a detachable short side of a UPP form 44 that creates the top of the UPP, and a detachable short side of a UPP form 47 that creates the bottom of a UPP. The form has an internal feature 45 that creates a horizontal channel void 8, and internal features 46 that create a vertical channel void 9.

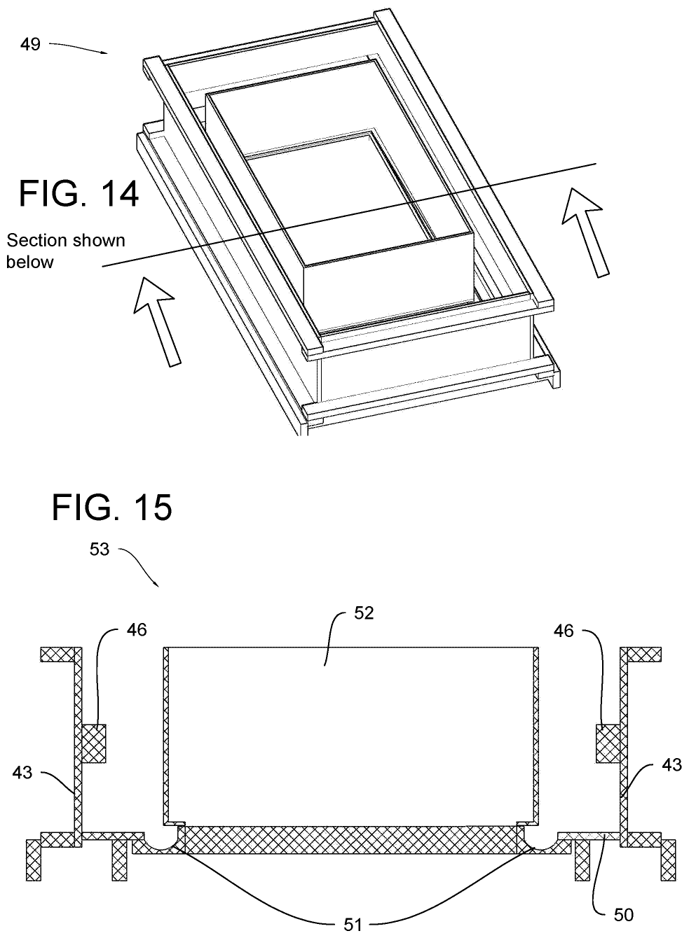

For convenience and efficiency the bottom piece 50 is placed on the floor, a mobile cart, or sawhorses and close to a substrate mixer 54 shown in FIG. 16. A form long side 43 and a form short side 44 are put in place on the frame and adjoining the bottom piece 50 and fastened in at least one of location H seen in FIG. 12. In the preferred embodiment the fastener is a quick release clamp. The other form long side 43 and form short side 47 are put into their positions and clamped at H. lifting hook 10 (not shown) is suspended inside the form with one portion of it penetrating through the internal feature 45 that creates horizontal channel void. An internal feature 48 that creates utility chase void 11 is fastened to form long sides 43 or placed in notches (not shown) in form long sides 43. The exterior window casing trim retainer form 51 is fastened to the bottom piece 50 of the form and the window void retainer form 52 passes through the bottom piece 50 and is fastened to the trim retainer form 51 The window void retainer form 52 has an angled edge that creates a sloped sill in the window panel for water shedding. A substrate is mixed and poured or placed into the form. After a time period for curing, the clamps or fasteners can be removed from H, and the sides 43, 44,47 can be removed from the cast panel. The panel can undergo further curing at this stage or be transported to storage or a job site for assembly. FIG. 14 illustrates a form 49 for a prefabricated window panel with a section line that is further illustrated in FIG. 15 by a vertical section 53 of window panel form 49. The section view depicts two internal features 46 that create a vertical channel void 9 (not shown), a form bottom piece 50, two form long sides 43, a window void retainer form 52 and an exterior window trim retainer form 51.

FIG. 16 shows a tool used as an element of the preferred embodiment: a large mixer 54 that may be filled by hopper from above and mix a large batch of substrate thereby filling one or more forms 41.

### Contemplated Compositions of the UPP

Some substrates used to manufacture the UPP may be a bio aggregate, hemperete, a fiber composite, a cellulose composite, aerated concrete or an inorganic composite. In the preferred embodiment, exterior or interior skins can encase a substrate used for the majority of the UPP, by pouring or troweling a skin material into the bottom of the form, placing a substrate, and after a curing time, pouring or troweling a material onto the top of the substrate. In the preferred embodiment said skin materials may be a lime plaster, and said substrate materials may be hemperete.

In another embodiment a UPP could be a single material like hemperete or aerated concrete where the finished appearance of the UPP is the appearance of the cured substrate. In many embodiments a single UPP provides thermal resistance, thermal mass, shear strength, structural support for the wet concrete, and finishes including exterior weather resistant finish. Upon assembly of UPPs and pouring reinforced concrete the wall is complete. Further additive layers, coats, or paints are unnecessary but may be used.

### Method of Assembly

The method of assembly of the UPP's relevant to the present disclosure begins after a foundation is in place.

Apply adhesive, spray foam or mortar at bottom of any UPP, Lift said UPP with provided hook 14 into position directly on flashing 34 on the foundation E or G, plumb and brace to ground stake. In one embodiment, at the base of the UPP's vertical channel void, vertical rebar may be fastened directly to the foundation by drilling a hole and fastening rebar into the hole with adhesive, or if a piece of rebar was stubbed out of the foundation, another piece 35 may be fastened to the first to continue to the height of the horizontal channel void.

Apply adhesive, spray foam or mortar to the side of the standing UPP and the bottom of a next UPP, then lift the next UPP with provided hook 14 and place next UPP against the first. The UPP may be plumbed and braced. Repeat with all UPPs saving a door panel assembly as the last panels to install. Place a door side panel 17, then place a temporary supporting wooden structure such as a door buck B shown in FIG. 1G against the first door side panel 17 and fasten it with fastener 21. After the door buck B is secured, the second door side panel 17 can be placed and the door header panel 18 can be placed on top of said door side panels and buck B.

The fasteners 21 that hold the door buck are in one embodiment a piece of threaded rod which extends into the channel void and after a load bearing material is poured into said void and cures, the threaded rod is anchored permanently. The door buck can be detached and the doorjamb can be predrilled with a countersink and bolted in place on the hinge side of the jamb. The opposite side jamb can be attached with a different type of fastener.

If desired, add horizontal rebar and tie to vertical rebar installed previously. Add additional braces as necessary to prepare for pouring a load bearing material. Double check that all UPPs are plumb and aligned properly.

Pour a load bearing material such as concrete into vertical voids. Set hurricane ties into concrete on layout desired for roof truss or ceiling rafters -OR- If higher levels are to be built up, do not place hurricane ties, but instead, insert steel joist hangers into the vertical surface at the desired second floor height with a portion of said joist hanger extending into the horizontal void. This specialized piece of hardware is known in the art and is also used in walls made with insulated concrete forms (ICF's).

After the load bearing material is cured, a second story floor can be built with standard wood framing techniques and the UPP's assembly method can continue by repeating all the above steps starting with: “apply adhesive, spray foam or mortar at bottom of any UPP” When the roof level is reached apply hurricane ties into wet concrete.

If a floor slab is to be poured after wall assembly as described in claim 15 and shown in FIG. 7 where the slab is captured inside of the wall panel, the following method is further followed after the method of assembly listed above. Ideally the floor is poured immediately following the concrete pour in the wall voids.

Chase voids 11,12,13 in adjoining UPPs provide a ring around an interior perimeter wherein the lower surface of said ring represents the height of a concrete floor slab to be poured and said lower surface serves as a level line and screed guide for pouring, striking, troweling and/or floating a concrete floor. Pour a concrete slab floor inside the building using the lower surface of the chase voids 11,12,13 as described. It may be noted by one skilled in the art of building that the doorway area would benefit from sloping the concrete slab slightly down toward the outside so that wind driven rain drains away from the door and off the foundation.

In both assembly methods listed above, said chase void ring also furnishes a utility chase above said floor and within the plane of the wall for efficient placement of plumbing, wiring or other utilities. Place utilities. After placement of utilities, cover said ring or utility chase 11,12,13 with a trim as shown in FIG. 7 such as baseboard 36.

Install windows in window voids 10 against flanges 16 that arrest thermal bridging and provide a drip edge away from the window jamb.

Further steps to complete a building are obvious to one skilled in the art of building and are not part of the claimed method. They include:, installing plumbing and electrical in one or more chases that were created during prefabrication by integral parts of the form. Covering chases with trim or otherwise filling with like substrate.

In one embodiment the electrical switch boxes and receptacle boxes locations' are determined for a specific building and the boxes and conduit are placed into the prefabrication form and cast into the substrate. In this embodiment the conduit would lead to a utility chase 11,12,13 where the wiring may continue.

Re-using forms implies a degree of uniformity in a structure and between structures. A given set of UPPs will create a concrete post and beam structure that is uniform in size and strength for a standard application such as small residential houses. Another given set of UPPs could be custom designed for any concrete post and beam size and strength required including large commercial buildings, in either case matching the set of forms to the job allows the use of the minimum amount of concrete necessary to bear the weight of connected building elements such as upper stories, decks or roof,

It should be noted that in order to properly benefit from the time efficiency gained by prefabrication, the re-use of forms dictates that the house be designed around the available dimensions given by addition of common panel lengths. If a home was designed to any size by an architect that was unaware of the common panel lengths then custom forms would have to be built anew at each corner or feature.

Further, the time savings achieved by the UPP system disclosed herein is intended for exterior walls but it can be used on interior walls as well and doing so may be of benefit by helping to maintain a space at a desired temperature with thermal mass.

### Preferred Embodiment

A series of wall building UPPs 4′ wide by 8′-6″ tall by 12″ to 20″ wide for residential or commercial construction made of hemperete consisting of lime based binder, hemp hurds and water are used as a substrate to fill reusable forms. The finished shape of the prefabricated UPPs allows for a continuous channel void that runs vertically up the 20″ wide side, across the 20″ wide top and down the other 20″ side. These prefabricated UPPs are placed side-by-side with other prefabricated UPPs including wall sections, corner sections, window panels and door panels assembled into a complete exterior wall perimeter. The continuous channel around the sides and top of each individual UPP create voids which are then filled with rebar and concrete. The cured concrete is in the shape of the time tested “post and beam” construction. The posts and beams are equidistant from the interior and exterior of the wall. The posts that are created are 4′ from center to center and the span of the beam above is less than 4′. The horizontal beam is also the window or door header eliminating the need for constructing a separate header as seen in SIP's or stick framing. The prefabricated UPPs plus the rebar and concrete create a monolithic structure of great strength. The concrete is all poured in one day around the entire perimeter of the exterior walls. The monolithic structure allows very little air infiltration through the wall field. When combined with good air sealing practices at the top and bottom, the wall system has a very high effective R-Value with almost zero thermal bridging and miniscule air infiltration. The lower portion of the concrete posts creates a mechanical bond with the foundation. The upper portion of the concrete beams include engineered “hurricane tie” anchors set into the wet concrete that securely fasten the roof structure onto the wall system. The wall system with concrete added provides compressive strength, insulation, shear strength, interior and exterior finishes, window trim, concrete floor slab height guide, electrical and plumbing chases and hurricane ties to attach the roof system.

The use of the words concrete and rebar are not intended to limit the claims of the invention to the use of reinforced portland concrete but instead to describe only one embodiment. However future embodiments may use a different material with similar properties of turning from liquid to solid in situ where said solid is load bearing. Another embodiment may place rigid structural members into the vertical and horizontal voids and fasten them together. The use of the word hemperete is not intended to limit the claims of the invention. A future embodiment may be composed of aerated concrete or other material.

It is to be realized that the scope of the present invention comprehends many equivalent methods and constructions. The showing of the drawings and the particular description are merely specific exemplifications of a plurality of embodiments and arrangements. Notwithstanding that the numerical ranges and parameters setting forth the broad scope of the inventions are approximations, the numerical values set forth in the specific examples are appropriate to the current embodiment. Any numerical value, however, inherently contains certain errors necessarily resulting from the standard deviation found in their respective testing measurement. Moreover, all ranges disclosed herein are to be understood to encompass any and all sub-ranges submitted therein, and every number between the endpoints. For example, a stated range of “1 to 10” should be considered to include any and all sub-ranges between (and inclusive of) the minimum value of 1 and the maximum value of 10; that is, all sub-ranges beginning with a minimum value of 1 or more, e.g. 1 to 6.1, and ending with a maximum value of 10 or less, e.g. 5.5 to 10, as well as all ranges beginning and ending with the endpoints, e.g. 2 to 9, 3 to 8, 3 to 9, 4 to 7, and finally to each number 1,2,3,4,5,6,7,8,9, and 10 contained within the range. It is further noted that, as used in this specification, the singular forms “a,” “an,” and “the” include plural references unless expressly and unequivocally limited to one referent

I Claim:

1. Prefabricated wall construction panels, comprising:
Variform panels with an inner surface that may be the completed inner surface of the wall and an outer surface that may be the completed outer surface of the wall, where said inner and outer surfaces may be planar, angled or curved,
with said inner and outer surfaces separated by a thickness spanned by two substantially vertical sides and two substantially horizontal sides,
said panel's thickness is substantially solid or solid with entrapped air or gas pockets or bubbles,
said vertical sides include a channel void or rabbet oriented longitudinally therein, that is one part of complementary profiles, that when adjoined with another panel at it's respective vertical side, the two panels may function as a team to enclose a void that may be the shape of a cylinder, rectangular prism, trapezoidal prism or post shape, hereinafter called a post,
said horizontal side or sides include a channel void or rabbet oriented longitudinally therein, that when at least two panels are adjoined at their vertical sides, a horizontal side channel void is adjoined to the respective horizontal channel void in the adjoining panels,
thereby providing a continuous horizontal channel void substantially above and contiguous with said vertical channel voids,
where all said voids are oriented between the interior and exterior skin,
said vertical and horizontal channels or rabbets are hereinafter called channel voids,
whereby said channel voids provide a means for placement of a load bearing structure.

2. Prefabricated wall construction panels according to claim one comprising:
Five types of panels, a wall section, a window section, a corner section a door side panel and a door header panel where,
A first type of panels called wall panels with substantially rectangular inner and outer surfaces or curved inner and outer surfaces,
A second type of panels with similar inner and outer surfaces to the wall panels but which also have a void for a window,
A third type of panels furnished for corners or angles with horizontal sides described by substantially 90 degree angles or other acute or obtuse angles,
with an inner surface or plurality of inner surface planes that are the completed inner surface of the wall, an outer surface or plurality of outer surface planes that are the completed outer surface of the wall,
A fourth type of prefabricated panel, where the same panel can be disposed to either side of a door jamb, where said panel has two substantially vertical sides of substantially door height and two substantially horizontal sides connecting said inner and outer surfaces, where the horizontal side or sides are substantially flat, where one vertical side of said panel includes a channel void and the other side is provided for attaching a door jamb,
a fifth type of prefabricated panel for a door header, disposed above two fourth type panels, that is alike to a first panel in feature and thickness but differs in height,
where the fifth type panel's vertical height is defined by the distance between the top of a fourth type panel and the top of the wall height,
wherein prefabricated panels are selected from the group of panels consisting of types 1 through 5 and combinations thereof and assembled as a substantially continuous, linear, angular or curved wall providing a continuous horizontal channel void in the shape of a monolithic beam substantially above and contiguous with said vertical channel voids

3. A series of prefabricated building panels with at least 3 sides rabbeted around their narrowest side perimeter, where said rabbet is for the purpose of concrete infill, where said panels are of a full ceiling height, whose method of manufacture, and method of assembly creates a complete wall containing the insulation, shear strength, water resistance, exterior skin and interior skin.

4. A prefabricated panel or panels provided for window placement, that includes flanges cast concurrently with the body of the panel, where said flanges intrude inward a distance into the window void on the upper and side portions of said void, providing a surface against which to mount a window jamb, situating said jamb away from the exterior of the building.

5. A prefabricated panel or panels according to claim 1, 2, or 3 wherein two or more panels are stacked to achieve full ceiling height.

6. A prefabricated panel or panels according to claim 1 or 2 wherein the thickness of the wall panel material between one side of said channel void and the inner or outer surface of the panel is approximately ⅓^{rd} to ⅕^{th} or more of the total wall thickness.

7. A prefabricated panel or panels according to claim 1, 2, 3 or 4, or any combination thereof, wherein features may further include a plumbing chase substantially at the base of the wall, an electrical chase, specialty vertical or horizontal chases, exterior window trim detail, interior window trim detail, exterior door trim detail, interior door trim detail, frieze board profile, board and batton trim profile, finials, corbles or other shapes or textures

8. A wall according to claim 1 or 2 wherein the load bearing member is reinforced concrete or other indurating liquid that mechanically bonds and air seals the panels together.

9. A prefabricated panel or panels according to claim 1, or 2, wherein said panel is a 3 layer composition consisting of a relatively thin layer of lime plaster for the finished wall's exterior skin followed by a substantially thicker layer of hemperete or other bio-aggregate that is coated on top with another relatively thin layer of lime plaster.

10. A series of prefabricated wall panels according to claim 1 or 2, that are substantially composed of aerated concrete.

11. A method of manufacture of wall building panels comprising:
Assembling a form of a shape according to claims, mixing substrate in a mixer,
pouring or placing a layer or layers of a liquid flowable substrate, semi-solid mixture or otherwise ductile, moldable or pliable mixture into forms composed of separable pieces that can be fastened with quick clamps or other fasteners and,
waiting a time, wherein said substrate cures or hardens taking the shape of the interior form features thereby creating a prefabricated panel,
removing said fasteners and forms.

12. A method of assembly of prefabricated panels to make a wall and connect or integrate other common building elements comprising:
connect lifting equipment to integrated hooks in panels and or to forms that are partially protectively encasing each panel and,
place panel, orienting said horizontal channel voids substantially horizontally, with the base of the panel arranged on top of a foundation wall, in a mortar bed, adhesive or spray foam bed and on a water-shedding flashing,
plumb and brace panel to ground or interior floor
optional placement of a reinforcement bar extending from floor to ceiling height, which may be fastened into the foundation, and extends upwards with a 90 degree angled bend extending horizontally in to the horizontal channel void at top of said panel,
apply an adhesive, spray foam or mortar to a vertical panel side, and to the next portion of the foundation,
placement of neighboring panel in adjoining position with vertical side pushed into previously placed adhesive, spray foam or mortar,
apply an adhesive, spray foam or mortar to a vertical panel side and apply a first door side panel against it, place a second door side panel opposite and mirror image to it and fit a temporary buck holding them away from each other and braced to the floor or ground, apply an adhesive, spray foam or mortar to the top of the two door panels,
place a door header panel on top of the two door panels,
complete door panel and header assembly with optional placement of a reinforcement bar extending from floor to ceiling height, which can be fastened into the foundation, and extending upwards with a 90 degree angled bend extending horizontally in to the horizontal channel void at top of said panel,
repeat said steps of vertical reinforcement bar placement, adhesive, spray foam or mortar placement, adjoining panel placement, including all wall panels, window panels, curved panels and corner panels or any combination thereof until the building wall perimeter is delineated,
place reinforcement bar in horizontal channel voids and fasten to vertical reinforcement bars,
if upper stories are desired, affix joist hanger brackets to interior surface with a portion extending into the horizontal channel void to be encased by or affixed to a load bearing material,
pour, pump or place a load bearing flowable material such as concrete into vertical and horizontal channel voids,
repeat above steps for upper levels if desired,
measure and mark roof truss or rafter placement on top of wall beside horizontal channel, place wind-uplift resistant roof fasteners into wet concrete or other load bearing material on marked layout.

13. A wall panel or series of wall panels with a horizontal chase void 6 or rabbet in the surface facing into a building at the substantially lower portion of the panel and longitudinally exposed on the surface of said panel, that when a multiplicity of like wall panels are placed in a perimeter creating a building's exterior walls each said chase void 6 is aligned continuously with the chase voids 6 in adjoining panels providing a ring around said perimeter wherein the lower surface of said ring represents the height of a concrete floor slab to be poured and said lower surface serves as a level line and screed guide for pouring, striking, troweling or floating a concrete floor, and further, said ring also furnishes a utility chase above said floor and within the plane of the wall for efficient placement of plumbing, wiring or other utilities where said ring and utilities may be covered with a trim such as baseboard 18.

14. The method of assembly and use of components according to any combination of claims in a wall building system and the building thereby created.
